(19) United States
(12) Patent Application Publication
(10) Pub. No.: US 2004/0117357 A1
(43) Pub. Date: Jun. 17, 2004

(54) Method, system and program product for identifying similar user profiles in a collection

(75) Inventors: Andrew L. Schirmer, Andover, MA (US); Marijane M. Zeller, Medford, MA (US)

Correspondence Address: IBM Corporation, N50/040-4, 1701 North Street, Endicott, NY, 13760, US

(73) Assignee: International Business Machines Corporation, Armonk, NY

(21) Appl. No.: 10/320,966

(22) Filed: Dec. 17, 2002

(51) Int. Cl. G06F 7/00

(52) U.S. Cl. 707/3

(57) ABSTRACT

Under the present invention, a collection of user profiles is provided. Each user profile includes one or more attributes that are associated with a set of data items. When a particular user profile is selected by a querying user, the data items therein are compared to the data items of the other user profiles. Any of the other user profiles that have data items that match those in the selected user profile will be identified as a similar user profile. A list of similar user profiles can then be generated and provided to the querying user.

### BACKGROUND OF THE INVENTION

1. Field of the Invention

The present invention generally relates to a method, system and program product for identifying similar user profiles in a collection. Specifically, under the present invention, similar user profiles in the collection are identified by matching data items therein.

2. Background Art

In the course of their daily lives, people make frequent connections to one another for various reasons. For example, connections are often made to obtain information, advice, or approval. Moreover, many connections are made for networking purposes. The explosion of computer technology has dramatically helped foster forming connections that were not previously likely. In many cases, people seeking to make connections today will utilize information contained within a user profile. To this extent, various systems exist for maintaining and providing access to user profiles. One example of such a system is Lotus Discovery Server, which is commercially available from International Business Machines of Armonk, N.Y.

Typically, a user profile includes one or more attributes (e.g., name, date of birth, etc.) of a user. Since each user can have his/her own user profile, the data items associated with the attributes often vary. In general, current search mechanisms require a querying user to search for other users by specifying particular data items for certain attributes in the user profiles. For example, if a querying user is searching for other users born in “New York,” the querying user would define a search criterion as such. Unfortunately, these search mechanisms are limited by both the querying user's ability to know or imagine the data items required to conduct the search, and by his/her ability to formulate the search criterion using the interfaces provided. In the case of the former, the querying user might not know the correct verbiage/taxonomy of the particular system. For example, one system might require a search criterion for users born in “New York” to be formulated using the initials “NY,” while another system might require the words “New York.” Unless the querying user knows this, the search using the improper criterion will likely be unsuccessful. In the case of the latter, the querying user might not be familiar with the particular search interface of the system he/she is using. Accordingly, the querying user might not define the most effective search criterion. For example, if the interface requires formulation of the search criterion based on Boolean expressions, and the querying user is unfamiliar with such, the resulting search criterion could be ineffective or even unusable by the system.

In view of the foregoing, there exists a need for a method, system and program product for identifying similar user profiles in a collection. Specifically, a need exists whereby a particular user profile in the collection can be selected. A further need exists for data items in the selected user profile to be compared to data items in the other user profiles to identify user profiles that are similar to the selected user profile.

### SUMMARY OF THE INVENTION

In general, the present invention relates to a method, system and program product for identifying similar user profiles in a collection. Specifically, a collection of user profiles is provided within a database or the like. Each of the user profiles typically has at least one attribute that is associated with a set (i.e., one or more) of data items. When one of the user profiles is selected by a user, a comparison is made between the data items in the selected user profile and the data items in the other user profiles. Any user profile having one or more data items that match any of the data items in the selected user profile is identified as a similar user profile. When the comparison is complete, a list of similar user profiles is generated. To this extent, the similar user profiles can be arranged in the list based on a quantity of matching data items. For example, the user profile having the most matching data items can appear first in the list.

According to a first aspect of the present invention, a computer-implemented method for identifying similar user profiles in a collection is provided. The computer-implemented method comprises: (1) providing a collection of user profiles, wherein each of the user profiles includes at least one attribute that is associated with a set of data items; (2) selecting one of the user profiles; and (3) identifying a set of similar user profiles by comparing the selected user profile to the other user profiles in the collection, wherein a similar user profile is identified when a data item of the selected user profile matches a corresponding data item of another one of the user profiles.

According to a second aspect of the present invention, a method for identifying similar user profiles in a database is provided. The method comprises: (1) providing a database containing user profiles, wherein each user profile has at least one attribute that is associated with at least one data item; (2) receiving a selection of one of the user profiles from a user; (3) comparing the at least one data item of the selected user profile to the at least one data item of the other user profiles in the database; and (4) generating a list of the user profiles having data item matches to the selected user profile.

According to a third aspect of the present invention, a system for identifying similar user profiles in a collection is provided. The system comprises: (1) a selection system for selecting one the user profiles in the collection, wherein each of the user profiles includes at least one attribute that is associated with a set of data items; (2) a comparison system for comparing the selected user profile to the other user profiles in the collection to identify a set of similar user profiles, wherein a similar user profile is identified when a data item of the selected user profile matches a corresponding data item of another one of the user profiles; and (3) a listing system for arranging the set of similar user profiles into a list.

According to, a fourth aspect of the present invention, a program product stored on a recordable medium for identifying similar user profiles in a collection is provided. When executed, the program product comprises: (1) program code for selecting one of the user profiles in the collection, wherein each of the user profiles includes at least one attribute that is associated with a set of data items; (2) program code for comparing the selected user profile to the other user profiles in the collection to identify a set of similar user profiles, wherein a similar user profile is identified when a data item of the selected user profile matches a corresponding data item of another one of the user profiles; and (3) program code for arranging the set of similar user profiles into a list.

Therefore, the present invention provides to a method, system and program product for identifying similar user profiles in a collection.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a search system, according to the present invention.

FIG. 2 depicts a selected user profile, according to the present invention.

FIG. 3 depicts a similar user profile, as identified according to the present invention

FIG. 4 depicts a list of similar user profiles, according to the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention relates to a method, system and program product for identifying similar user profiles in a collection. Specifically, a collection of user profiles is provided within a database or the like. Each of the user profiles typically has at least one attribute (e.g., Name, Date of Birth, etc.) that is associated with a set (i.e., one or more) of data items (e.g., Name—Joe Smith). When one of the user profiles is selected by a user, a comparison is made between the data items in the selected user profile and the data items in the other user profiles. Any user profile having one or more data items that match any of the data items in the selected user profile is identified as a similar user profile. When the comparison is complete, a list of similar user profiles is generated. To this extent, the similar user profiles can be arranged in the list based on a quantity of matching data items. For example, the user profile having the most matching data items can appear first in the list.

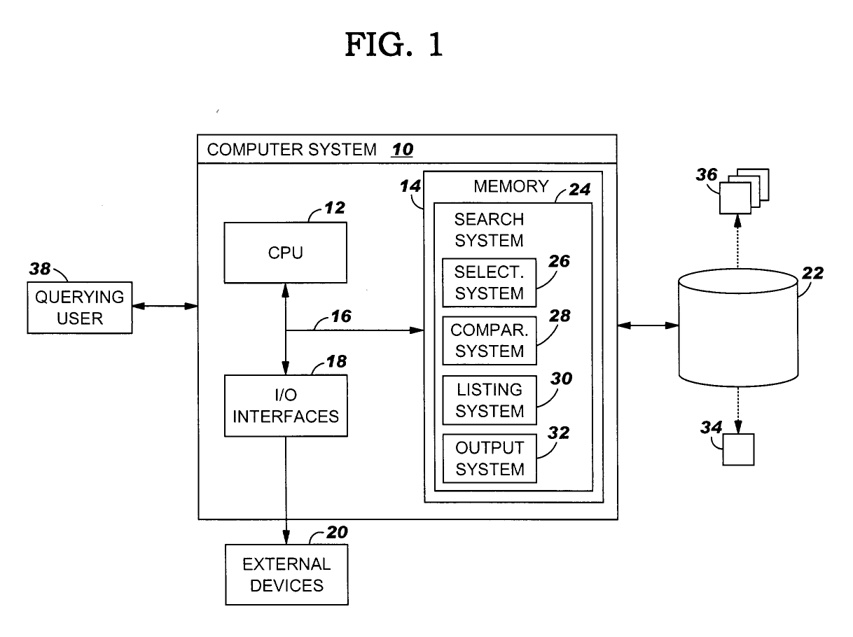

Referring now to FIG. 1, computer system 10 having search system 24 is shown. In general, computer system 10 is intended to represent any type of computerized system that can be accessed by querying user 38 for identifying similar user profiles. As depicted, computer system 10 generally comprises central processing unit (CPU) 12, memory 14, bus 16, input/output (I/O) interfaces 18, external devices/resources 20 and database 22. CPU 12 may comprise a single processing unit, or be distributed across one or more processing units in one or more locations, e.g., on a client and server. Memory 14 may comprise any known type of data storage and/or transmission media, including magnetic media, optical media, random access memory (RAM), read-only memory (ROM), a data cache, a data object, etc. Moreover, similar to CPU 12, memory 14 may reside at a single physical location, comprising one or more types of data storage, or be distributed across a plurality of physical systems in various forms.

I/O interfaces 18 may comprise any system for exchanging information to/from an external source. External devices/resources 20 may comprise any known type of external device, including speakers, a CRT, LED screen, hand-held device, keyboard, mouse, voice recognition system, speech output system, printer, monitor, facsimile, pager, etc. Bus 16 provides a communication link between each of the components in computer system 10 and likewise may comprise any known type of transmission link, including electrical, optical, wireless, etc. In addition, although not shown, additional components, such as cache memory, communication systems, system software, etc., may be incorporated into computer system 10.

Database 22 provides storage for information under the present invention. Such information could include, for example, a collection of user profiles, etc. As such, database 22 may include one or more storage devices, such as a magnetic disk drive or an optical disk drive. In another embodiment, database 22 includes data distributed across, for example, a local area network (LAN), wide area network (WAN) or a storage area network (SAN) (not shown). Database 22 may also be configured in such a way that one of ordinary skill in the art may interpret it to include one or more storage devices.

It should be understood that communication with computer system 10 can occur via a direct hardwired connection (e.g., serial port), or via an addressable connection in a client-server (or server-server) environment that may utilize any combination of wireline and/or wireless transmission methods. In the case of the latter, the server and client may be connected via the Internet, a wide area network (WAN), a local area network (LAN), a virtual private network (VPN) or other private network. The server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

In general, the user profiles are typically stored prior to or concurrent with execution of the present invention. To this extent, the user profiles could be established, stored and/or updated using any technology now known or later developed. Such technology could be provided within memory 14 of computer system 10, although this need not be the case. For example, the user profiles could have been provided from an external computer system (not shown) and stored in database 22 for computer system 10 to access.

Stored in memory 14 of computer system 10 is search system 24. As shown, search system 24 includes selection system 26, comparison system 28, listing system 30 and output system 32. In general, when querying user 38 selects a particular user profile 34, a set (e.g., one or more) of similar user profiles 36 can be identified. For example, using selection system 26, querying user 38 can select a particular user profile 34. To this extent, selection system 26 could include any arrangement of interfaces and program code that allows querying user 38 to specifically identify, search for, or choose from a list a particular user profile 34.

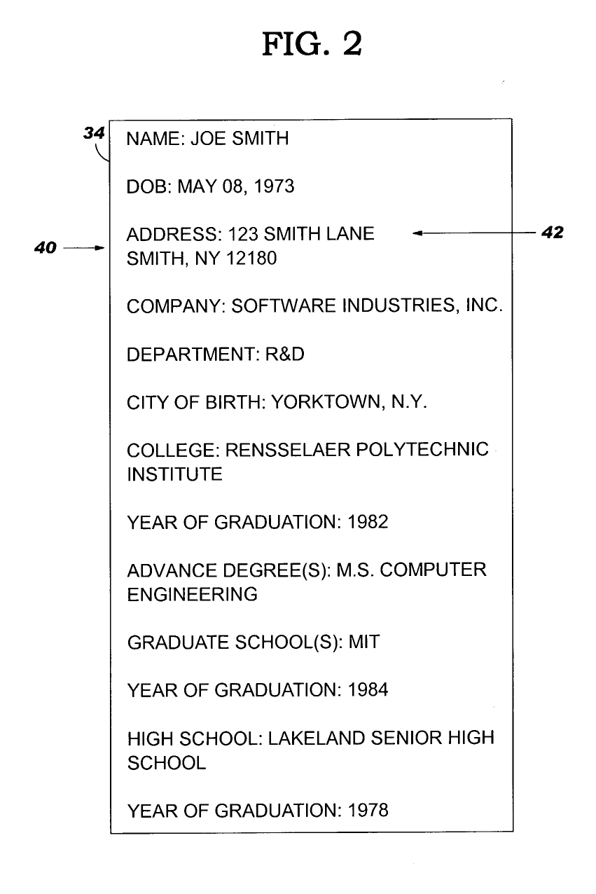

Referring to FIG. 2, selected user profile 34 is shown in greater detail. In this example, selected user profile 34 is a user profile for “Joe Smith.” As shown, selected user profile 34 include attributes 40 that are each associated with one or more data items 42. For example, attribute “Name” is associated with two data items, namely, “Joe” and “Smith.” It should be understood that the present invention does not require each attribute to be associated with a set of data items. That is, certain attributes could be left blank. For example, if “Joe Smith” did not receive any advance degree, the “Advanced Degree(s)” attribute could be blank.

In any event, once particular user profile 34 has been selected, a set of similar user profiles 36 will be identified. Specifically, referring back to FIG. 1, after user profile 34 has been selected, comparison system 28 will compare user profile 34 to the other user profiles in database 22 in an attempt to identify a set of similar profiles 36. In a typical embodiment, comparison system 28 will compare data items 42 of user profile 34 to the data items of the other user profiles in the collection (e.g., as stored in database 22). A similar user profile is identified when one of data items 42 matches a corresponding data item of another user profile. To this extent, comparison system 28 could formulate any type of search criterion based on data items 42, and then use the search criterion to identify the set of similar user profiles 36. For example, if a selected user profile has attribute “A” with the data items “n, o, p and q” and attribute “B” with the data items “r, s and t,” comparison system 28 could formulate the following search criterion:

SELECT user profile WHERE A=(n OR o OR p OR q) OR B=® OR s OR t). Under this search criterion, any other user profile with a matching data item for a corresponding attribute will be identified as a similar user profile. It should be understood, however, that the search criterion shown above is only intended to be illustrative and that any other search criterion could be implemented to identify a set of similar user profiles 36. For example, a search criterion could require that all data items (e.g., n, o, p and q) of an attribute (e.g., attribute A) to be present in a corresponding attribute of another user profile in order for the other user profile to be considered a similar user profile. Still yet, a search criterion could require that one or more data values for a plurality of attributes match before the other user profile is considered to be a similar user profile.

In any event, based on data items 42 of selected user profile 34, comparison system 28 will formulate a search criterion to identify the set of similar user profiles. To this extent, comparison system 28 could compare data items 42 to those in all other profiles, or to a group/subset (less than all) of the other profiles. Such a group could be designated by querying user 38 according to specifically selected attributes and/or data items. For example, querying user 38 could indicate that he/she only wants selected user profile 34 to be compared to other user profiles that identify the same “Company” as selected user profile 34. In designating a group of user profiles in such a manner, querying user 38 could select one or more attributes and/or data values that appear in selected user profile 34 via a “grouping” interface or the like (e.g., as provided by selection system 26 or comparison system 28). In another embodiment, instead of referring to attributes and/or data items in selected user profile 34, querying user 38 could use the “grouping” interface to manually identify the attributes and/or data values that other profiles must contain to be compared to selected user profile 34. For example, querying user 38 could require that another profile must contain a particular year of birth (e.g., 1966) to be compared to selected user profile 34. In any event, selected user profile 34 could be compared to all other profiles, or to a group of the other profiles as designated by querying user 38.

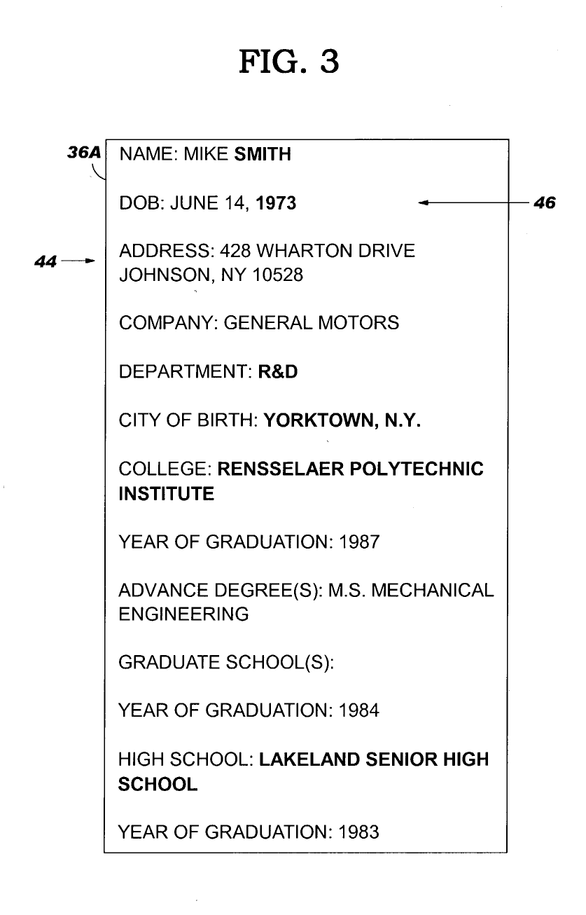

Referring to FIG. 3, an illustrative similar user profile 36A as identified by comparison system 28 is shown. As depicted, similar user profile 36A includes attributes 44 (e.g., Name, Date of Birth, etc.) that correspond to attributes 40 of selected user profile 34 (although a precise match is not necessary). Comparison system 28 identified user profile 36A based on certain data items 46 matching corresponding data items 42 in selected user profile 34. For example, the data item “Smith” in the attribute “Name” of similar user profile 36A matched data item “Smith” in the “Name” attribute of selected user profile 34 (FIG. 2). Under the present invention, when determining if data items “match,” comparison system 28 will only consider “corresponding” data items. For example, if the data item “Smith” appeared in the “Company” attribute of user profile 36A, it would not be considered a match to the “Smith” data item in the “Name” attribute of selected user profile 34. All data items of similar user profile 36A that matched those of selected user profile 34 are shown in FIG. 3 in boldface.

It should be understood that each attribute can be associated with any quantity of data items. For example, the “Name” attribute could be considered to have two data items, “Mike” and “Smith,” associated therewith. It is not important whether such data items are considered to be two separate data items or one whole data item. To this extent, comparison system 28 could be subject to a minimum quantity criterion, wherein only user profiles that have a minimum number (e.g., 3) of matching data items will be identified as being similar to user profile 34.

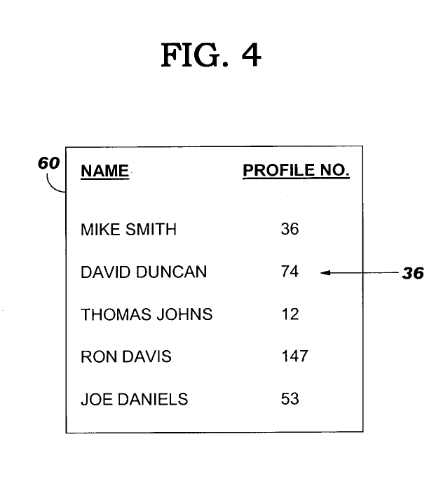

In any event, once all similar user profiles have been identified, listing system will arrange the set of similar user profiles 36 into a list. Under the present invention, the set of similar user profiles 36 can be arranged in the list in any manner. For example, referring to FIG. 4, the set of similar user profiles 36 is arranged in list 60 based on a quantity of matching data items. That is, each similar user profile is listed according to the number of data items it contained that matched data items 42 in selected profile 40. For example, the profile for “Mike Smith” could have contained ten matching data items while, the profile for “David Duncan” could have contained eight matching data items. List 60 could also include an identifier that corresponds to each similar user profile in the collection. For example, the profile for “Mike Smith” could be user profile number “36” in a collection of “500” profiles. In any event, once list 60 has been generated, output system 32 (FIG. 1) can provide the same to querying user 38. To this extent, list 60 as presented to querying user 38 could include hyperlinks or the like for easy access of the similar user profiles.

It should be understood that the present invention can be realized in hardware, software, or a combination of hardware and software. Any kind of computer/server system(s)- or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A computer-implemented method for identifying similar user profiles in a collection, comprising:
providing a collection of user profiles, wherein each of the user profiles includes at least one attribute that is associated with a set of data items;
selecting one of the user profiles; and
identifying a set of similar user profiles by comparing the selected user profile to other user profiles in the collection, wherein a similar user profile is identified when a data item of the selected user profile matches a corresponding data item of another one of the user profiles.

2. The method of claim 1, wherein the collection of user profiles are stored in a database.

3. The method of claim 1, wherein the selecting step comprises receiving a selection of one of the user profiles from a querying user.

4. The method of claim 3, further comprising:
arranging the set of similar user profiles into a list; and
providing the list to the user.

5. The method of claim 4, wherein the set of similar user profiles is arranged into the list based on a quantity of matching data items.

6. The method of claim 1, further comprising formulating a search criterion based on the at least one data item of the selected user profile, wherein the set of similar user profiles is identified using the search criterion.

7. The method of claim 6, wherein the search criterion requires a data item of the selected user profile to matches a corresponding data item of another one of the user profiles for more than one attribute for a similar profile to be identified.

8. The method of claim 1, wherein the selected user profile is compared to a group of the other user profiles in the collection, and wherein the group is designated by the querying user.

9. A method for identifying similar user profiles in a database, comprising:
providing a database containing user profiles, wherein each user profile has at least one attribute that is associated with at least one data item;
receiving a selection of one of the user profiles from a querying user;
comparing the at least one data item of the selected user profile to the at least on data item of the other user profiles in the database; and
generating a list of the user profiles having data item matches to the selected user profile.

10. The method of claim 9, further comprising outputting the list to the querying user.

11. The method of claim 9, wherein the user profiles having the data item matches are arranged in the list according to a quantity of matched data items.

12. The method of claim 9, wherein each of the user profiles in the collection corresponds to an individual user.

13. A system for identifying similar user profiles in a collection, comprising:
a selection system for selecting one the user profiles in the collection, wherein each of the user profiles includes at least one attribute that is associated with a set of data items;
a comparison system for comparing the selected user profile to the other user profiles in the collection to identify a set of similar user profiles, wherein a similar user profile is identified when a data item of the selected user profile matches a corresponding data item of another one of the user profiles; and
a listing system for arranging the set of similar user profiles into a list.

14. The system of claim 13, wherein the collection is stored in a database.

15. The system of claim 13, wherein the selecting system receives a selection of one of the user profiles from a querying user.

16. The system of claim 13, further comprising an output system for outputting the list.

17. The system of claim 13, wherein the set of similar user profiles is arranged into the list based on a quantity of matching data items.

18. The system of claim 13, wherein the comparison system formulates a search criterion based on the set of data items of the selected user profile, wherein the set of similar user profiles is identified using the search criterion.

19. The system of claim 18, wherein the search criterion requires a data item of the selected user profile to matches a corresponding data item of another one of the user profiles for more than one attribute for a similar profile to be identified.

20. The system of claim 13, wherein the selected user profile is compared to a group of the other user profiles in the collection, and wherein the group is designated by the querying user.

21. A program product stored on a recordable medium for identifying similar user profiles in a collection, which when executed, comprises:
program code for selecting one of the user profiles in the collection, wherein each of the user profiles includes at least one attribute that is associated with a set of data items;
program code for comparing the selected user profile to the other user profiles in the collection to identify a set of similar user profiles, wherein a similar user profile is identified when a data item of the selected user profile matches a corresponding data item of another one of the user profiles; and
program code for arranging the set of similar user profiles into a list.

22. The program product of claim 21, wherein the collection is stored in a database.

23. The program product of claim 21, wherein the program code for selecting receives a selection of one of the user profiles from a querying user.

24. The program product of claim 21, further comprising program code for outputting the list.

25. The program product of claim 21, wherein the set of similar user profiles is arranged into the list based on a quantity of matching data items.

26. The program product of claim 21, wherein the program code for comparing formulates a search criterion based on the set of data items of the selected user profile, wherein set of similar user profiles is identified using the search criterion.

27. The program product of claim 26, wherein the search criterion requires a data item of the selected user profile to matches a corresponding data item of another one of the user profiles for more than one attribute for a similar profile to be identified.

28. The program product of claim 21, wherein the selected user profile is compared to a group of the other user profiles in the collection, and wherein the group is designated by the querying user.
